(19) United States
(12) Patent Application Publication
(10) Pub. No.: US 2025/0338847 A1
(43) Pub. Date: Nov. 6, 2025

(54) FORMULATION

(71) Applicant: SYNGENTA CROP PROTECTION AG, Basel (CH)

(72) Inventors: Clair STUART, Bracknell, Berkshire (GB); Gemma HALLAM-BARNES, Bracknell, Berkshire (GB); Andrew James COUGHLIN, Greensboro, NC (US); Beverley MASON, Bracknell, Berkshire (GB)

(73) Assignee: SYNGENTA CROP PROTECTION AG, Basel (CH)

(21) Appl. No.: 18/869,146

(22) PCT Filed: May 23, 2023
(86) PCT No.: PCT/EP2023/063797

§ 371 Date: Nov. 25, 2024

(30) Foreign Application Priority Data
May 30, 2022 (EP) 22176170.3

(51) Int. Cl. A01N 43/80; A01N 25/04; A01N 25/10; A01P 7/04

(52) U.S. Cl. CPC A01N 43/80; A01N 25/04; A01N 25/10; A01P 7/04

(57) ABSTRACT

This invention relates to a composition comprising: (a) isocycloseram, and (b) a lignin compound having an average molecular weight up to 10000 g/mol.

This invention relates to a composition comprising isocycloseram. More particularly, this invention relates to formulations such as dispersible concentrates; to dilutions of such formulations more particularly in a farmer's spray-tank; and to use of such a composition to combat and/or control of an animal pest.

Isocycloseram is an insecticidal agrochemical. However, it has been found that with such active ingredient, conventional formulation approaches present a number of problems, such as for example formulations are difficult to stabilise on dilution, as the use of water miscible solvents promotes crystal growth of active ingredients with low water solubility, and the formulations are often not very tolerant to condition changes such as variation in dilution rate, temperature and water quality amongst other parameters.

The aim of the present invention is to overcome the problems of the prior art techniques by proposing a composition comprising isocycloseram, having a stable dilution while guaranteeing a good solubility, especially at 100 g/l of isocycloseram.

To this end, an object of the present invention is to provide a composition comprising:
(a) isocycloseram, and
(b) a lignin compound having an average molecular weight up to 10000 g/mol

Thanks to the combination of said lignin compound with isocycloseram, all the above problems have been overcome.

Isocycloseram is an insecticidal agrochemical with the following CAS number: 2061933-85-3, and has the following chemical formula:

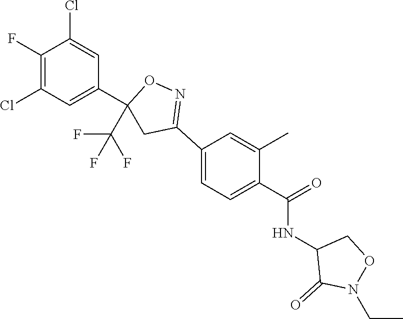 [SMILES: CCN1OCC(NC(=O)c2ccc(C3=NOC(c4cc(Cl)c(F)c(Cl)c4)(C(F)(F)F)C3)cc2C)C1=O]

Isocycloseram can comprise the isomer (5S,4R) which is 4-[(5S)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide (CAS number: 1309959-62-3), and optionally at least one of the isomers selected among isomer (5S,4S), isomer (5R,4R), isomer (5R,4S), and any combinations thereof. In the present invention, the isomer (5S,4S) is 4-[(5S)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide; the isomer (5R,4R) is 4-[(5R)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide; and the isomer (5R,4S) is 4-[(5R)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide. When isocycloseram further comprises at least one of the isomers selected among isomer (5S,4S), isomer (5R,4R), isomer (5R,4S), and any combinations thereof, isocycloseram can comprise a molar proportion of the isomer (5S,4R) greater than 50%, e.g. at least 55%, 60%, 65%, 70%, 75%, 80%, 85%, 90%, 95%, 96%, 97%, 98% or 99%, over the total amount of the isomers (5S,4R), (5S,4S), (5R,4R) and (5R,4S).

The composition according to the present invention can comprise from 0.01% to 70% by weight of isocycloseram, preferably from 0.1% to 50% by weight of isocycloseram, preferably from 1% to 30% by weight of isocycloseram, and more preferably from 5% to 20% by weight of isocycloseram, over the total weight of the composition.

The lignin compound according to the present invention can have an average molecular weight up to 5000 g/mol. In a preferred embodiment, the lignin compound can have an average molecular weight of at least 1000 g/mol.

In the present invention, the expression “an average molecular weight” means a molecular weight approximately of. Molecular weight of a lignin compound, or in other words the molar mass, can be easily determined by method well-known in the art, such as gel permeation chromatography (GPC).

The lignin compound according to the present invention can be more particularly a kraft lignin.

In another particular embodiment, the lignin compound can be an unsulfonated lignin. In a preferred embodiment, the lignin compound can be an unsulfonated kraft lignin.

An unsulfonated kraft lignin can be defined as a lignin separated from cellulose using the Kraft process (also known as sulfate process), namely separation using sodium hydroxide (NaOH) and sodium sulfide (Na₂S). The use of this process gives rise to unsulfonated lignins, unlike those produced via an acidic sulfite process.

The composition according to the present invention can comprise from 0.01% to 30% by weight of the lignin compound, preferably 0.1% to 20% by weight of the lignin compound, and more preferably from 0.1% to 10% by weight of the lignin compound, over the total weight of the composition.

The composition according to the present invention can further comprise (c) an acrylic graft copolymer.

The acrylic graft copolymer has typically a comb- or star-like structure, and preferably a comb-like structure.

Graft copolymers are branched copolymers wherein the components forming the side chains are structurally different from the components forming the main chain.

Comb-like polymers comprise of a main chain (backbone) which contains branch points from each of which a linear side chain emanates.

Star-like polymers comprise of a multifunctional centre from which at least three polymer chains radiate.

In a preferred embodiment, the acrylic graft copolymer can be an amphipathic copolymer.

More particularly, the acrylic graft copolymer comprises at least one component A, which is solvated by an aqueous medium (hydrophilic part), and at least one other component B which is hydrophobic.

Suitable acrylic graft copolymers may comprise polyethylene glycol, mono-methyl ethers of polyethylene glycol, poly(vinyl pyrrolidone), poly(acrylamide) or poly(vinyl alcohol) as hydrophilic side chain, while the hydrophobic backbone may comprise polymers and copolymers of styrene, methyl acrylate, methyl methacrylate, ethyl acrylate, 2-ethylhexyl acrylate, lauryl methacrylate, or vinyl acetate.

Such acrylic graft copolymers can for example be prepared by converting the mono-methyl ether of a polyethylene glycol to the acrylic or methacrylic ester, which is then subjected to radical polymerization with other unsaturated monomers such as styrene, ethyl acrylate, or methyl methacrylate. It is also possible to prepare such acrylic graft copolymers by reacting a hydrophobic polymer backbone, which consists chemically reactive sites such as carboxyl, hydroxy, or amine groups, with monomeric alkylene oxides, such as ethylene oxide and propylene oxide, to form hydrophilic side chains.

More preferably, the acrylic graft copolymer is a non-ionic polymer, and more particularly with a comb-like structure.

In the present invention, the acrylic graft copolymer can comprise polyethylene glycol and/or mono-ether polyethylene glycol side chains.

The acrylic graft copolymer can also comprise a backbone obtained from acrylate and/or methacrylate monomers.

Even more preferably, the acrylic graft copolymer can comprise a backbone obtained from acrylate and/or methacrylate monomers, and side chains comprising polyethylene glycol and/or mono-ether polyethylene glycol, giving more particularly the polymer a comb-like structure.

For example, the acrylic graft copolymer of the present invention can be Agrilan 755 supplied by Nouryon, Atlox 4913™ supplied by CRODA, or Tersperse 2500™ supplied by HUNTSMAN.

The composition according to the present invention can comprise from 0.01% to 30% by weight of the acrylic graft copolymer, preferably from 0.1% to 20% by weight of the acrylic graft copolymer, and more preferably from 0.1% to 10% by weight of the acrylic graft copolymer, over the total weight of the composition.

The composition according to the present invention can further comprise (d) a lactamide compound.

The lactamide compound can be more particularly of formula I

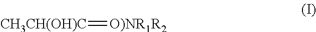

wherein R₁ and R₂ are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR₃R₄ where R₃ and R₄ are each independently C₁₋₃ alkyl; or phenyl optionally substituted by up to three substituents independently selected from C₁₋₃ alkyl; or R₁ and R₂ together with the nitrogen atom to which they are attached form a morpholinyl, pyrrolidinyl, piperidinyl or azepanyl ring, each of which is optionally substituted by up to three substituents independently selected from C₁₋₃ alkyl,

In a preferred embodiment, R₁ and R₂ of the lactamide compound of formula I can be each independently hydrogen or C₁₋₆ alkyl, and more preferably hydrogen or C₁₋₃ alkyl such as lactic acid dimethyl amide or lactic acid diethyl amide.

The composition according to the present invention can comprise from 10% to 90% by weight of the lactamide compound, preferably from 20% to 80% by weight of the lactamide compound, and more preferably from 30% to 70% by weight of the lactamide compound, over the total weight of the composition.

The composition according to the present invention can further comprise (e) an ether type solvent.

The ether type solvent can be selected among dialkyl ethers, dialkyl amide ethers, glycol ethers, aliphatic ethers, and cyclic ethers.

For example, the ether type solvent can be methyl-5-(dimethylamino)-2-methyl-5-oxopentanoate, diethylene glycol monomethyl ether, diethylene glycol monoethyl ether, diethylene glycol monobutyl ether, diethylene glycol monophenyl ether, tetrahydrofuran or dibutyl ether.

The composition according to the present invention can comprise from 1% to 70% by weight of the ether type solvent, preferably from 1% to 60% by weight of the ether type solvent, and more preferably from 10% to 50% by weight of the ether type solvent, over the total weight of the composition.

When the composition comprises a lactamide compound as defined in the present invention, the amount of the ether type solvent is preferably lower than the amount of lactamide compound.

In a particular embodiment of the present invention, especially to form dispersible concentrates (DC), the composition may comprise:
(a) from 0.01% to 70% by weight of isocycloseram, preferably from 0.1% to 50% by weight of isocycloseram, preferably from 1% to 30% by weight of isocycloseram, and more preferably from 5% to 20% by weight of isocycloseram, over the total weight of the composition;
(b) from 0.01% to 30% by weight of the lignin compound, preferably 0.1% to 20% by weight of the lignin compound, and more preferably from 0.1% to 10% by weight of the lignin compound, over the total weight of the composition;
(c) optionally from 0.01% to 30% by weight of the acrylic graft copolymer, preferably from 0.1% to 20% by weight of the acrylic graft copolymer, and more preferably from 0.1% to 10% by weight of the acrylic graft copolymer, over the total weight of the composition;
(d) optionally from 10% to 90% by weight of the lactamide compound, preferably from 20% to 80% by weight of the lactamide compound, and more preferably from 30% to 70% by weight of the lactamide compound, over the total weight of the composition; and
(e) optionally from 1% to 70% by weight of the ether type solvent, preferably from 1% to 60% by weight of the ether type solvent, and more preferably from 10% to 50% by weight of the ether type solvent, over the total weight of the composition.

In said particular embodiment, the isocycloseram, the lignin compound, the acrylic graft copolymer, the lactamide compound and the ether type solvent are the compounds described in the present description.

The composition of the present invention may further comprise one or more formulation additives well-known in the art. In particular, the formulation additives can be selected among an anti-freeze agent, an anti-foam agent, an anti-bacterial agent (or biocide), a viscosity modifier (or thickener), a pH modifier, and any mixture thereof. More preferably, the formulation additives can be selected among an anti-foam agent, a pH modifier, and any mixture thereof.

Other suitable formulation additives include amongst others known to the person skilled in the art, antioxidant, emulsifying agent, colourant (or pigment), perfume, adjuvant, attractant, buffer, coating agent, deodorant, emetic agent, inorganic filler, safener, organic solvent, photo-protecting agent, and any mixture thereof.

The composition of the present invention may comprise a suitable amount of one or several of the above-mentioned formulation additive(s) to obtain the respective properties, when appropriate.

The composition of the present invention may further comprise an additional agrochemical. The additional agrochemical can be an insecticide, a fungicide, an herbicide, a synergist, a plant growth regulator, a nematicide, a plant nutrient, a plant fertilizer, and a mixture thereof.

The composition of the present invention may comprise a suitable amount of one or several of the above-mentioned additional agrochemical(s) to obtain the respective properties, when appropriate.

For example, the additional agrochemical can be selected from: acibenzolar-s-methyl, metalaxyl-M, metalaxyl, picarbutrazox, oxathiapiprolin, ethaboxam, fludioxonil, azoxystrobin, thiabendazole, difenoconazole, tebuconazole, ipconazole, mefentrifluconazole, prothioconazole, triticonazole, sedaxane, inpyrfluxam, penflulen, fluopyram, fluxapyroxad, pydifulmetofen, cylobutrifluram, thiamethoxam, isoflucypyram, chlothianidin, benzovindiflupyr, cymoxanil, phosphite (phosphonate), silthiofam, pyraclostrobin, isotianil, tolprocarb, quinofumelin, ipflufenoquin, metyltetraprole, florylpicoxamid, fenpicoxamid, fluoxytioconazole, fluindapyr, isoflucypram, fluoxapiprolin, broflanilide, imidacloprid, acetamiprid, cyantraniliprole, chlorantraniliprole, tetraniliprole, fluxamethamide, penthiopyrad, mandipropamid, dimpropyridaz, flupyrimin, triflumezopyrim, oxazosulfyl, dichlobentiazox, benzpirimoxan, hymexazol, pyrapropoyne, cyclaniliprole, mandestrobin, copper, lambda-cyhalothrin, phenamacril, abamectin, tefluthrin, picoxystrobin, spiropidion, oligosaccharins, Melaleuca alternifolia, fosthiazate, fenamifos, oxamyl, fluensulfone, Fluazanindolizine, spirotetramat, spidoxamat, fluazinam, indazapyroxamet, thiophanate methyl, zoxamide, fluoxastrobin, pirimifos, tetrachlorantraniliprole, bifenthrin, and emamectin.

In another object of the present invention, the composition can be advantageously used to prepare a dispersible concentrate (DC).

In a particular embodiment, the composition of the present invention may relate to:
a concentrate designed to be added to a farmer's spray tank of water or it may be applied directly without further dilution, or
a suspension produced in a farmer's spray tank of water when a concentrate is mixed with water in the spray tank.

In another object of the present invention, the present invention relates to a method of combating and/or controlling an animal pest, which comprises applying to the pest, to a locus of the pest, or to a plant susceptible to attack by the pest, the composition according to the present invention.

The animal pest can be an invertebrate animal pest, such as insects, acarines, nematodes or molluscs.

The term “plant” as used herein includes seedlings, bushes and trees.

The composition according to the present invention can be used for combating and/or controlling (i.e. containing or destroying) pests of the abovementioned type which occur in particular on plants, especially on useful plants and ornamentals in agriculture, in horticulture and in forests, or on organs, such as fruits, flowers, foliage, stalks, tubers or roots, of such plants, and in some cases even plant organs which are formed at a later point in time remain protected against these pests.

Suitable target crops are, in particular, cereals, such as wheat, barley, rye, oats, rice, maize (e.g. field corn, popcorn, corn), millet or sorghum; beet, such as sugar or fodder beet; fruit, for example pomaceous fruit, stone fruit or soft fruit, such as apples, pears, plums, peaches, almonds, cherries or berries, for example strawberries, raspberries or blackberries; leguminous crops, such as beans, lentils, peas or soya (soya beans); oil crops, such as oilseed rape, mustard, poppies, olives, sunflowers, coconut, castor, cocoa or ground nuts; cucurbits, such as pumpkins, cucumbers, melons, watermelons or squashes; fibre plants, such as cotton, flax, hemp or jute; citrus fruit, such as oranges, lemons, grapefruit or tangerines; vegetables, such as spinach, lettuce, asparagus, cabbages, broccolis, cauliflowers, carrots, onions, tomatoes, potatoes, eggplants, peppers or bell peppers; Lauraceae, such as avocado, Cinnamonium or camphor; and also tobacco, nuts, coffee, sugarcane, tea, grapevines, hops, the plantain family and latex plant.

In this method, the composition can be generally applied with an effective amount of isocycloseram.

More preferably, said method is applied in spraying the composition of the present invention, for example dispensed from a spray container.

Said method can involve an effective amount of the composition applied at a rate of from 0.01 to 5 Litre per Hectare (L/ha), and more preferably from 0.02 to 3.0 L/ha.

In another object of the present invention, the composition can be a seed treatment formulation, or in other words a plant propagation material can be treated with the composition according to the invention. The term “plant propagation material” is understood to denote all the generative parts of the plant, such as seeds, which can be used for the multiplication of the latter including vegetative plant material such as cuttings. There may be mentioned, as plant propagation material, seeds (in the strict sense), roots, fruits, tubers, bulbs, rhizomes, parts of plants. The plant propagation material can be treated with the composition of the invention before the material is sown or planted. Alternatively, the plant propagation material may be treated with the composition of the invention during sowing or planting. Additionally, the composition of the invention may be applied to the previously treated propagation material before or during its planting. The composition of the invention may be applied during the sowing of the seed. The composition may also be used to plant propagation material derived from plants grown in a green house and/or during transplantation. Said seed treatment formulation can be applied with rates ranging of from 10 mg to 1 g of active substance (isocycloseram) per kg of seeds, preferably from 10 mg to 500 mg of active substance (isocycloseram) per kg of seeds, and more preferably from 10 mg to 100 mg of active substance (isocycloseram) per kg of seeds.

In another object of the present invention, the composition may also be used as animal health treatment.

The following non-limiting examples demonstrate the improved behaviour associated with a composition according to the present invention. The compounds used in the following examples are detailed below.
Isocycloseram is an insecticide under the CAS number 2061933-85-3;
Lignin compound 1 is the product Indulin AT (CAS number 8068 May 1) supplied by Ingevity, which is a kraft lignin with an average molecular weight of 2700 g/mol;
Lignin compound 2 is the product Borresperse NA (CAS number 8061-51-6) supplied by Borregaard, which is a lignosulfonate with an average molecular weight of 20000 g/mol;
Copolymer is the product Agrilan 755 supplied by Nouryon, comprising 30% by weight of acrylic graft copolymer, 50% by weight of propylene glycol, and 20% by weight of water;
Lactamide compound is the product Agnique AMD 3L (CAS number: 35123-06-9) supplied by BASF;
Ether solvent is the product Rhodiasolv Polarclean (CAS number: 1174627-68-9) supplied by Solvay.

The concentrations of the components in Examples 1-4, expressed in percentage by weight over the total weight of the composition (% w/w), are gathered in Table 1.

Examples 1-4 are prepared as follows: the required amounts of the lactamide compound and ether solvent are weighed into an appropriate vessel and mixed until homogenous. The required amount of isocycloseram is then added under mixing and left until the isocycloseram has visibly dissolved. Optionally the mixture can be heated up to 40° C. to speed up dissolution. The acrylic graft copolymer and lignin compound is then added, still under mixing, and the formulation left to stir until homogenous and cooled back to ambient temperature (25° C.) if required.

TABLE 1

| | Composition | | | | | |
|---|---|---|---|---|---|---|
| | | | | | Lignin | Lignin |
| | | | Lactamide | Ether | compound | compound |
| | Isocycloseram | Copolymer | compound | solvent | 1 | 2 |
| Ex. | (% w/w) | (% w/w) | (% w/w) | (% w/w) | (% w/w) | (% w/w) |
| 1 | 9.50 | 4.70 | 63.50 | 21.80 | 0.50 | 0 |
| 2 | 9.50 | 4.70 | 42.65 | 42.65 | 0.50 | 0 |
| 3 | 9.50 | 4.70 | 63.50 | 21.80 | 0 | 0.50 |
| 4 | 9.50 | 4.70 | 42.65 | 42.65 | 0 | 0.50 |

Table 2 gathers the results based on the following assessments:
Dissolution: After preparation of the formulation, the sample is examined by eye to determine whether all of the solid matter in the formulation has fully dispersed or not. This test determines whether the lignin compound is fully dispersed in the formulation. The presence of undispersed lignin compound is observed as brown/black particulate matter.
Dilution properties: The dilution properties of the formulation were assessed according to CIPAC method MT180, varying the water type, temperature and dilution rate as shown in the table below. In this test, both the opacity of the dilution and the amount of sediment was recorded. A dispersible concentrate formulation with good dilution stability has less than 0.1 ml of sediment present after 24 hr of standing.

TABLE 2

| | Results | | | | | | |
|---|---|---|---|---|---|---|---|
| | | Opacity | Opacity | Opacity | Sediment | Sediment | Sediment |
| | | SHW A, | SHW D, | SHW A, | SHW A, | SHW D, | SHW A, |
| | | 30° C., 24 | 30° C., 24 | 5° C., 24 hr, | 30° C., 24 | 30° C., 24 | 5° C., 24 hr, |
| | | hr, 0.3% | hr, 0.3% | 0.3% | hr, 0.3% | hr, 0.3% | 0.3% |
| Ex. | Dissolution | Dilution | Dilution | Dilution | Dilution | Dilution | Dilution |
| 1 | Dispersed | Hazy | Hazy | Hazy | None | None | None |
| 2 | Dispersed | Semi- | Semi- | Hazy | <0.1 ml | <0.1 ml | <0.1 ml |
| | | transparent | transparent | | | | |
| 3 | Not | — | — | — | — | — | — |
| | dispersed | | | | | | |
| 4 | Not | — | — | — | — | — | — |
| | dispersed | | | | | | |

The invention claimed is:

1. A composition comprising:
(a) isocycloseram, and
(b) a lignin compound having an average molecular weight up to 10000 g/mol.

2. A composition according to claim 1, characterized in that the lignin compound has an average molecular weight up to 5000 g/mol.

3. A composition according to claim 1, characterized in that the lignin compound has an average molecular weight of at least 1000 g/mol.

4. A composition according to claim 1, characterized in that the lignin compound is a kraft lignin.

5. A composition according to claim 1, characterized in that the lignin compound is an unsulfonated lignin.

6. A composition according to claim 1, characterized in that it comprises from 0.01% to 70% by weight of isocycloseram, preferably from 0.1% to 50% by weight of isocycloseram, preferably from 1% to 30% by weight of isocycloseram, and more preferably from 5% to 20% by weight of isocycloseram, over the total weight of the composition.

7. A composition according to claim 1, characterized in that it comprises from 0.01% to 30% by weight of the lignin compound, preferably 0.1% to 20% by weight of the lignin compound, and more preferably from 0.1% to 10% by weight of the lignin compound, over the total weight of the composition.

8. A composition according to claim 1, characterized in that the composition further comprises (c) an acrylic graft copolymer.

9. A composition according to claim 8, characterized in that it comprises from 0.01% to 30% by weight of the acrylic graft copolymer, preferably from 0.1% to 20% by weight of the acrylic graft copolymer, and more preferably from 0.1% to 10% by weight of the acrylic graft copolymer, over the total weight of the composition.

10. A composition according to claim 1, characterized in that the composition further comprises (d) a lactamide compound.

11. A composition according to claim 10, characterized in that it comprises from 10% to 90% by weight of the lactamide compound, preferably from 20% to 80% by weight of the lactamide compound, and more preferably from 30% to 70% by weight of the lactamide compound, over the total weight of the composition.

12. A composition according to claim 1, characterized in that the composition further comprises (e) an ether type solvent.

13. A composition according to claim 12, characterized in that it comprises from 1% to 70% by weight of the ether type solvent, preferably from 1% to 60% by weight of the ether type solvent, and more preferably from 10% to 50% by weight of the ether type solvent, over the total weight of the composition.

14. A composition comprising:
(a) isocycloseram,
(b) a lignin compound having an average molecular weight up to 10000 g/mol,
(c) an acrylic graft copolymer,
(d) a lactamide compound, and
(e) an ether type solvent.

15. A composition according to claim 1, characterized in that it is used to prepare a dispersible concentrate.

16. A method of combating and/or controlling an animal pest, which comprises applying to the pest, to a locus of the pest, or to a plant susceptible to attack by the pest, the composition according to claim 1.
